(19) United States
(12) Patent Application Publication
(10) Pub. No.: US 2025/0279503 A1
(43) Pub. Date: Sep. 4, 2025

(54) BATTERY MODULE AND BATTERY PACK INCLUDING THE SAME

(71) Applicant: LG Energy Solution, Ltd., Seoul (KR)

(72) Inventors: Sunghwan Jang, Daejeon (KR); Junyeob Seong, Daejeon (KR); Myungki Park, Daejeon (KR); Min Seop Kim, Daejeon (KR)

(21) Appl. No.: 18/274,427

(22) PCT Filed: Feb. 14, 2022
(86) PCT No.: PCT/KR2022/002140

§ 371 Date: Jan. 18, 2024

(30) Foreign Application Priority Data
Feb. 23, 2021 (KR) 10-2021-0024303
Jan. 28, 2022 (KR) 10-2022-0013634

(51) Int. Cl. H01M 10/6556; H01M 10/613; H01M 10/617; H01M 10/647; H01M 10/653; H01M 10/6551; H01M 50/211; H01M 50/627; H01M 50/691

(52) U.S. Cl. CPC H01M 10/6556; H01M 10/613; H01M 10/617; H01M 10/647; H01M 10/653; H01M 10/6551; H01M 50/627; H01M 50/691; H01M 50/211

(57) ABSTRACT

A battery module including: a battery cell stack in which a plurality of battery cells including electrode leads protruding in mutually opposite directions are stacked; a housing that houses the battery cell stack; a first heat sink and a second heat sink that are located under the bottom part of the housing, and first and second refrigerant flow paths formed between the first heat sink and the bottom part of the housing and between the second heat sink and the bottom part of the housing, respectively. The refrigerant flow path formed by the first heat sink and the refrigerant flow path formed by the second heat sink are separated from each other.

### CROSS-REFERENCE TO RELATED APPLICATIONS

This application is a US national stage of international application No. PCT/KR2022/002140 filed on Feb. 14, 2022, and claims benefit of priority to Korean patent application No. 10-2021-0024303 filed on Feb. 23, 2021, and Korean patent application No. 10-2022-0013634 filed on Jan. 28, 2022, the entire contents of which are incorporated as if fully set forth herein.

### TECHNICAL FIELD

The present disclosure relates to a battery module and a battery pack including the same, and more particularly, to a battery module having improved cooling performance and a battery pack including the same.

### BACKGROUND

In modern society, as portable devices such as a mobile phone, a notebook computer, a camcorder, and a digital camera are being used daily, the development of technologies in the fields related to mobile devices as described above has been activated. In addition, chargeable/dischargeable secondary batteries are used as a power source for an electric vehicle (EV), a hybrid electric vehicle (HEV), a plug-in hybrid electric vehicle (P-HEV) and the like, in an attempt to solve air pollution and the like caused by existing gasoline vehicles using fossil fuel. Therefore, there is a growing need for development of the secondary battery.

Currently commercialized secondary batteries include a nickel cadmium battery, a nickel hydrogen battery, a nickel zinc battery, and a lithium secondary battery. Among these, the lithium secondary battery has come into the spotlight because they have advantages, for example, hardly exhibiting memory effects compared to nickel-based secondary batteries and thus being freely charged and discharged and having very low self-discharge rate and high energy density.

Such lithium secondary batteries mainly use a lithium-based oxide and a carbonaceous material as a positive electrode active material and a negative electrode active material, respectively. The lithium secondary battery includes an electrode assembly in which a positive electrode plate and a negative electrode plate, each being coated with the positive electrode active material and the negative electrode active material, respectively, are disposed with a separator being interposed between them, and a battery case which seals and houses the electrode assembly together with an electrolyte solution.

Generally, the lithium secondary battery may be classified based on the shape of the exterior material into a can type secondary battery in which the electrode assembly is built into a metal can, and a pouch-type secondary battery in which the electrode assembly is built into a pouch of an aluminum laminate sheet.

In the case of a secondary battery used for small-sized devices, two to three battery cells are disposed in the secondary battery, but in the case of a secondary battery used for a medium- or large-sized device such as an automobile, a battery module in which a large number of battery cells are electrically connected is used. In such a battery module, a large number of battery cells are connected to each other in series or parallel to form a cell assembly, thereby improving capacity and output. In addition, one or more battery modules can be mounted together with various control and protection systems such as a battery management system (BMS) and a cooling system to form a battery pack.

When the temperature of the secondary battery rises higher than an appropriate temperature, the performance of the secondary battery may deteriorate, and in the worst case, there is also a risk of an explosion or ignition. In particular, heat generated from the large number of battery cells in a narrow space of a battery module or battery pack having a large number of secondary batteries, so that the temperature can rise more quickly and excessively. In other words, a battery module in which a large number of battery cells are stacked, and a battery pack equipped with such a battery module can obtain high output, but it is not easy to remove heat generated from the battery cells during charging and discharging. When the heat dissipation of the battery cells is not properly performed, deterioration of the battery cells is accelerated, the lifespan is shortened, and the possibility of explosion or ignition increases.

Moreover, a medium- or large-sized battery module included in a vehicle battery pack is frequently exposed to direct sunlight and can be subjected to high-temperature conditions such as in the summer or in desert areas.

Therefore, it may be very important to stably and effectively ensure the cooling performance when a battery module or a battery pack is configured.

FIG. 1 is a perspective view showing a conventional battery module. FIG. 2 is a cross-sectional view along the cutting line A-A′ of FIG. 1. In particular, a heat transfer member and a heat sink located under the battery module are further shown in FIG. 2.

Referring to FIGS. 1 and 2, the conventional battery module 10 is configured such that a plurality of battery cells 11 are stacked to form a battery cell stack 20, and the battery cell stack 20 is housed in the housing 30.

As described above, since the battery module 10 includes a plurality of battery cells 11, it generates a large amount of heat in a charge and discharge process. As a cooling means, the battery module 10 may include a thermal conductive resin layer 40 that is located between the battery cell stack 20 and the bottom part 31 of the housing 30. In addition, when the battery module 10 is mounted on a pack frame to form a battery pack, a heat transfer member 50 and a heat sink 60 may be sequentially located under the battery module 10. The heat transfer member 50 may be a heat dissipation pad. The heat sink 60 may have a refrigerant flow passage formed therein.

The heat generated from each of the plurality of the battery cells 11 is transmitted to the outside through the thermal conductive resin layer 40, the bottom portion 31 of the housing 30, the heat transfer member 50, and the heat sink 60 in this order.

In the conventional battery module 10, the heat transfer path is complicated as described above and thus, it is difficult to effectively transfer the heat generated from the battery cells 11. The housing 30 itself may deteriorate heat transfer properties, and a fine air layer such as an air gap, which can be formed in the space between the housing 30, the heat transfer member 50, and the heat sink 60. may also be a factor that deteriorates the heat transfer properties.

As for the battery module, it can be said that it is practically necessary to develop a battery module capable of satisfying these various requirements while improving the cooling performance because other demands such as an increase in capacity are also continuing.

### SUMMARY

It is an objective of the present disclosure to provide a battery module having improved cooling performance and a battery pack including the same.

However, the problem to be solved by embodiments of the present disclosure is not limited to the above-described problems, and can be variously expanded within the scope of the technical idea included in the present disclosure.

According to one embodiment of the present disclosure, there is provided a battery module comprising: a battery cell stack in which a plurality of battery cells including electrode leads protruding in mutually opposite directions are stacked; a housing that houses the battery cell stack; a first heat sink and a second heat sink that are located under the bottom part of the housing; first and second refrigerant flow paths formed between the first heat sink and the bottom part of the housing and between the second heat sink and the bottom part of the housing, respectively, wherein the first refrigerant flow path formed by the first heat sink is separated from the second refrigerant flow path formed by the second heat sink.

The first heat sink and the second heat sink may be located separately from each other along a direction parallel to a direction in which the electrode leads protrude.

The battery module may further comprise a first thermal conductive resin layer and a second thermal conductive resin layer that are located between the lower surface of the battery cell stack and the bottom part of the housing.

The first thermal conductive resin layer and the second thermal conductive resin layer may be located separately from each other along a direction parallel to a direction in which the electrode leads protrude.

The first heat sink may be located at a portion corresponding to the first thermal conductive resin layer, and the second heat sink is located at a portion corresponding to the second thermal conductive resin layer, with respect to a direction perpendicular to one surface of the bottom part of the housing.

The first heat sink may comprise a first lower plate that is joined to the bottom part of the housing, and a first recessed part that is recessed in a lower direction from the first lower plate.

The battery module may further comprise a thermal conductive resin layer located between the lower surface of the battery cell stack and the bottom part of the housing.

The thermal conductive resin layer may cover a region where the first heat sink is located and a region where the second heat sink is located, with respect to a direction perpendicular to one surface of the bottom part of the housing.

The housing may comprise one or more first housing protrusion parts that protrude from a part of the bottom part of the housing, and a refrigerant injection port that may be connected to any one of the first housing protrusion parts and a refrigerant discharge port that may be connected to any other one of the protrusion parts.

The first heat sink may comprise first heat sink protrusion parts that protrudes from one side of the first heat sink to portions where the first housing protrusion parts are located.

The second heat sink may comprise a second lower plate that is joined to the bottom part of the housing, and a second recessed part that is recessed in a lower direction from the second lower plate.

The housing may comprise one or more second housing protrusion parts that protrude from a part of the bottom part of the housing, and a refrigerant injection port that may be connected to any one of the second housing protrusion parts, and a refrigerant discharge port that may be connected to any other one of the second housing protrusion parts.

The second heat sink may comprise second heat sink protrusion parts that protrudes from one side of the second heat sink to portions where the second housing protrusion parts are located.

According to another embodiment of the present disclosure, there is provided a battery pack comprising: the battery module; a first pack refrigerant supply tube that supplies a refrigerant to a refrigerant flow path formed by a first heat sink; a first pack refrigerant discharge tube that discharges the refrigerant from the refrigerant flow path formed by the first heat sink; a second pack refrigerant supply tube that supplies a refrigerant to the refrigerant flow path formed by the second heat sink; and a second pack refrigerant discharge tube that discharges the refrigerant from the refrigerant flow path formed by the second heat sink.

According to embodiments of the present disclosure, the thermal conductive resin layer and the heat sink are concentrically arranged in the portion where heat generation is excessive in the battery cells, thereby being capable of improving the cooling performance and reducing the temperature deviation of the battery cells.

Additionally, the length of the refrigerant flow path of the heat sink relative to the cooling area of the battery module can be shortened, and thus the pressure drop of the refrigerant flow path can be improved.

Moreover, the cooling performance can be improved through the integrated structure of the housing and the heat sink.

Further, by removing unnecessary cooling structures, it is possible to reduce costs, improve space utilization, and increase the capacity or output of the battery module.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is a perspective view of a conventional battery module;

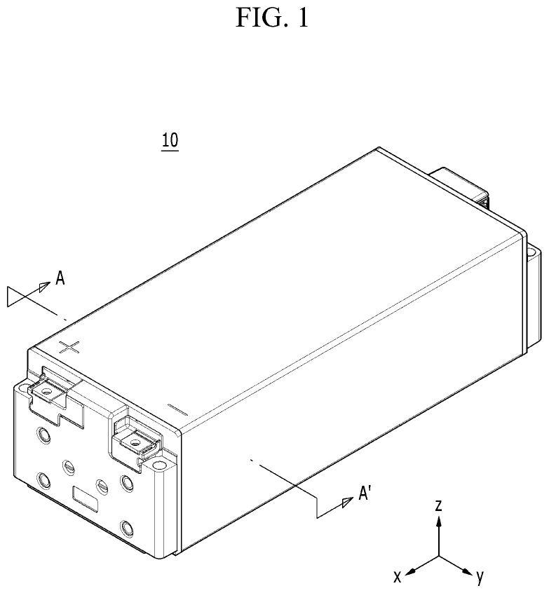

FIG. 2 is a cross-sectional view along line A-A′ of FIG. 1;

FIG. 3 is a perspective view of a battery module according to an embodiment of the present disclosure;

FIG. 4 is an exploded perspective view of the battery module of FIG. 3;

FIG. 5 is a perspective view of one of the battery cells included in the battery module of FIG. 4;

FIG. 6 is a perspective view of a first heat sink and a second heat sink included in the battery module of FIG. 4;

FIG. 7 is a cross-sectional view along line I-I′ of FIG. 6;

FIG. 8 is a perspective view of the battery module as viewed from the bottom to the top showing the lower surface of the battery module of FIG. 3;

FIG. 9 is a perspective of a lower frame, a first thermal conductive resin layer, and a second thermal conductive resin layer included in the battery module of FIG. 4;

FIG. 10 is a cross-sectional view along line B-B′ of FIG. 3;

FIG. 11 is a cross-sectional view along line C-C′ of FIG. 3;

FIG. 12 is a perspective view of a battery module, a pack refrigerant supply tube, and a pack refrigerant discharge tube according to an embodiment of the present disclosure;

FIG. 13 is an exploded perspective view of a battery module according to another embodiment of the present disclosure; and

FIG. 14 is a perspective view of a lower frame and a thermal conductive resin layer included in the battery module of FIG. 13.

### DETAILED DESCRIPTION

Hereinafter, various embodiments of the present disclosure will be described in detail with reference to the accompanying drawings so that those skilled in the art can easily carry out these embodiments. The present disclosure may be modified in various different ways and is not limited to the embodiments set forth herein.

A description of parts not related to the description will be omitted herein for clarity, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of some layers and regions are exaggerated.

In addition, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, the word “on” or “above” means disposed on or below a reference portion, and does not necessarily mean being disposed on the upper end of the reference portion toward the opposite direction of gravity.

Further, throughout the description, when a portion is referred to as “including” a certain component, it means that the portion can further include other components, without excluding the other components, unless otherwise stated.

Further, throughout the description, when referred to as “planar”, it means when a target portion is viewed from the upper side, and when referred to as “cross-sectional”, it means when a target portion is viewed from the side of a cross section cut vertically.

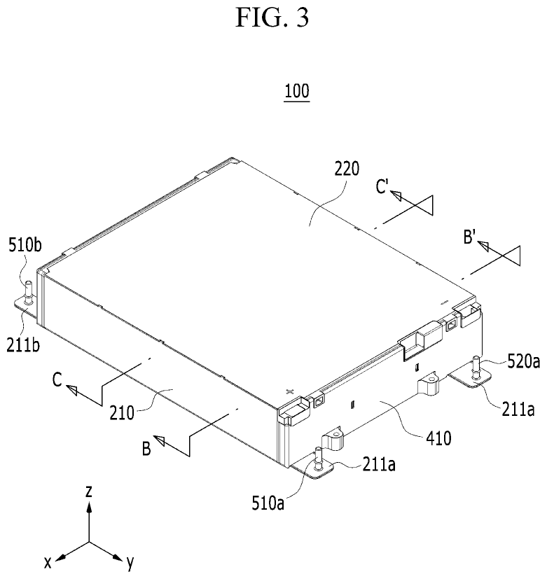

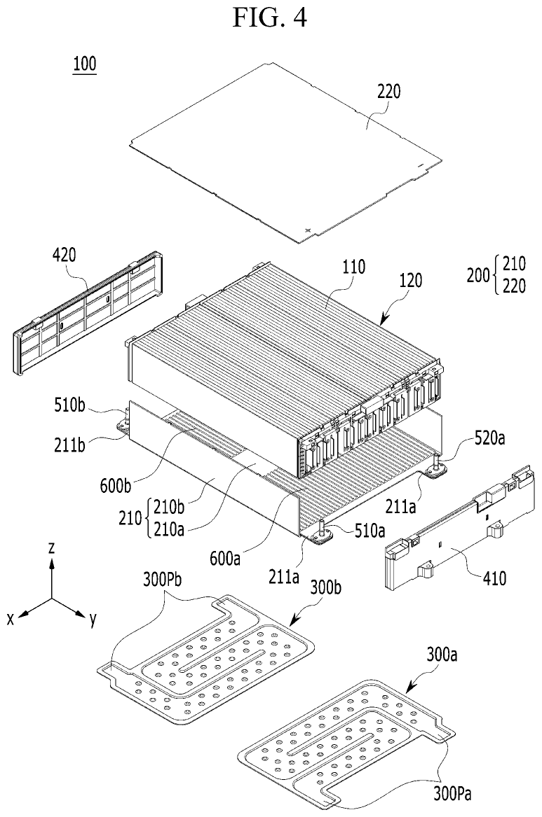

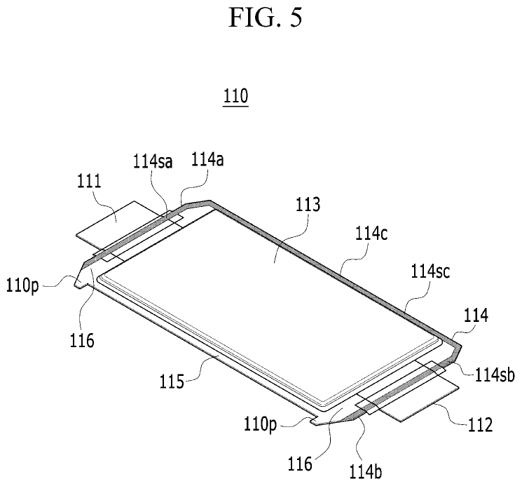

FIG. 3 is a perspective view of a battery module according to an embodiment of the present disclosure. FIG. 4 is an exploded perspective view of the battery module of FIG. 3. FIG. 5 is a perspective view of one of the battery cells included in the battery module of FIG. 4.

Referring to FIGS. 3 to 5, a battery module 100 includes a battery cell stack 120 in which a plurality of battery cells 110 are stacked; a housing 200 that houses the battery cell stack 120; and a first heat sink 300a and a second heat sink 300b that are located under the bottom part 210a of the housing.

First, the battery cell 110 is preferably a pouch type battery cell and may be formed in a rectangular sheet-like structure. For example, the battery cell 110 according to the present embodiment has a structure in which two electrode leads 111 and 112 face each other and protrude from one end 114a and the other end 114b of a cell body 113, respectively. That is, the battery cell 110 includes electrode leads 111 and 112 protruding in mutually opposite directions. More specifically, the first and second electrode leads 111 and 112 are connected to an electrode assembly (not shown) and protrude from the electrode assembly (not shown) to the outside of the battery cell 110.

Meanwhile, the battery cell 110 can be produced by joining both end parts 114a and 114b of a cell case 114 and one side part 114c connecting them in a state in which an electrode assembly (not shown) is housed in a cell case 114. In other words, the battery cell 110 according to the present embodiment has a total of three sealing parts 114sa, 114sb and 114sc, the sealing parts 114sa, 114sb and 114sc have a structure sealed by a method such as heat fusion, and the remaining other side part may be composed of a connection part 115. The cell case 114 may be composed of a laminate sheet including a resin layer and a metal layer.

In addition, the connection part 115 may extend long along one edge of the battery cell 110, and a bat-ear 110p may be formed at an end part of the connection part 115. Further, while the cell case 114 is sealed with the protruding electrode leads 111 and 112 being interposed at ends thereof, a terrace part 116 may be formed between the electrode leads 111 and 112 and the cell body 113. That is, the battery cell 110 includes a terrace part 116 formed to extend from the cell case 114 in a protruding direction of the electrode leads 111 and 112.

A plurality of battery cells 110 may be present, and the plurality of battery cells 110 may be stacked to be electrically connected to each other, thereby forming a battery cell stack 120. Particularly, as shown in FIG. 4, a plurality of battery cells 110 may be stacked along a direction parallel to the x-axis. Thereby, the electrode leads 111 and 112 may protrude in the +y-axis direction and the −y-axis direction, respectively. Although not specifically shown in the figure, an adhesive member may be located between the battery cells 110. Thereby, the battery cells 110 may be adhered to each other to form the battery cell stack 120.

The battery cell stack 120 according to the present embodiment may be a large-area module in which the number of battery cells 110 is larger than that of the conventional case. Specifically, 32 to 48 battery cells 110 can be included per battery module 100. In the case of such a large-area module, the horizontal length of the battery module becomes long. Here, the horizontal length may mean a length in the direction in which the battery cells 110 are stacked, that is, in a direction parallel to the x-axis.

When the battery cell 110 is repeatedly charged and discharged, heat is generated, and a large amount of heat is generated in the portions adjacent to the electrode leads 111 and 112. That is, more heat is generated during charge and discharge as approaching the terrace part 116 rather than the central part of the cell body 113.

The housing 200 for housing the battery cell stack 120 may include a lower frame 210 and an upper cover 220.

The lower frame 210 may include a bottom part 210a and two side parts 210b extending upward at both ends of the bottom part 210a. The bottom part 210a may cover the lower surface of the battery cell stack 120, and the two side parts 210b may cover both side surfaces of the battery cell stack 120. Here, the lower surface of the battery cell stack 120 refers to a surface in the −z-axis direction, and both side surfaces of the battery cell stack 120 refer to surfaces in the +x-axis and −x-axis directions. However, these are surfaces mentioned for convenience of explanation, and may differ depending on the position of a target object or the position of an observer, and the like.

The upper cover 220 may have a single plate-shaped structure that wraps the remaining upper surface (surface in the z-axis direction) excluding the lower surface and both side surfaces of the battery cell stack 120 that is wrapped by the lower frame 210. The upper cover 220 and the lower frame 210 are joined by welding in the state where mutually corresponding edge parts are in contact with each other, thereby forming a structure wrapping the battery cell stack 120 vertically and horizontally. The battery cell stack 120 can be physically protected through the upper cover 220 and the lower frame 210. For this purpose, the upper cover 220 and the lower frame 210 may include a metal material to have a predetermined strength.

Meanwhile, although not specifically shown in the figure, the housing 100 according to a modified embodiment of the present disclosure may be a mono frame in the form of a metal plate in which the upper part, the lower part, and both side parts are integrated. That is, this frame may have a structure in which the upper part, the lower part, and both side parts are integrated by being manufactured using extrusion molding, rather than a structure in which the lower frame 210 and the upper cover 220 are joined with each other.

Meanwhile, the battery module 100 according to the present embodiment may include a first end plate 410 and a second end plate 420 each covering the front surface and the rear surface of the battery cell stack 120, respectively. Here, the front surface of the battery cell stack 120 refers to a surface in the +y-axis direction, and the rear surface of the battery cell stack 120 refers to a surface in the −y-axis direction.

The first end plate 410 and the second end plate 420 are located at both open sides of the housing 200 so that they can be formed to cover the battery cell stack 120. Each of the first end plate 410 and the second end plate 420 may be joined by welding in the configuration where corresponding edges of the housing 200 are in contact with each other. The first end plate 410 and the second end plate 420 can physically protect the battery cell stack 120 and other electrical components from external impacts.

Meanwhile, although not specifically shown in the figure, a bus bar frame to which the bus bar is mounted and an insulating cover for electrical insulation can be located between the battery cell stack 120 and each of the end plates 410 and 420.

Next, the first and second heat sinks according to the present embodiment will be described in detail with reference to FIGS. 4 and 6 to 9.

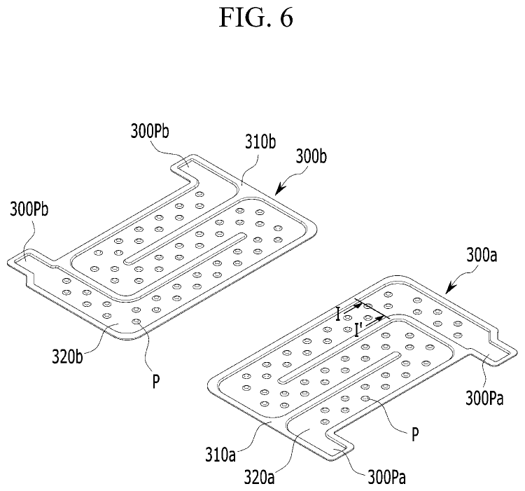

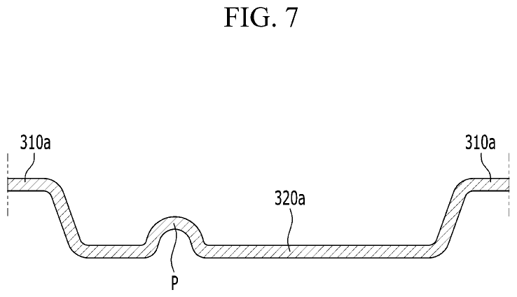

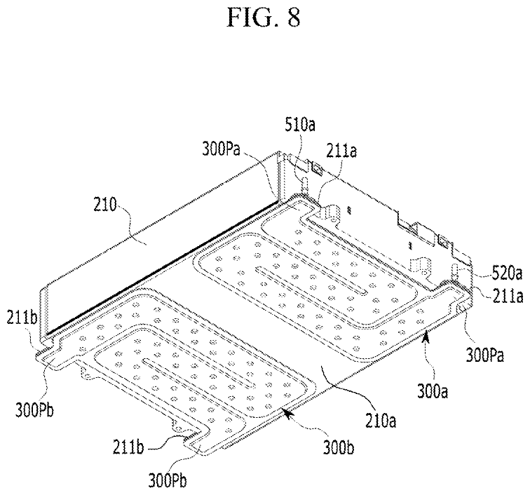

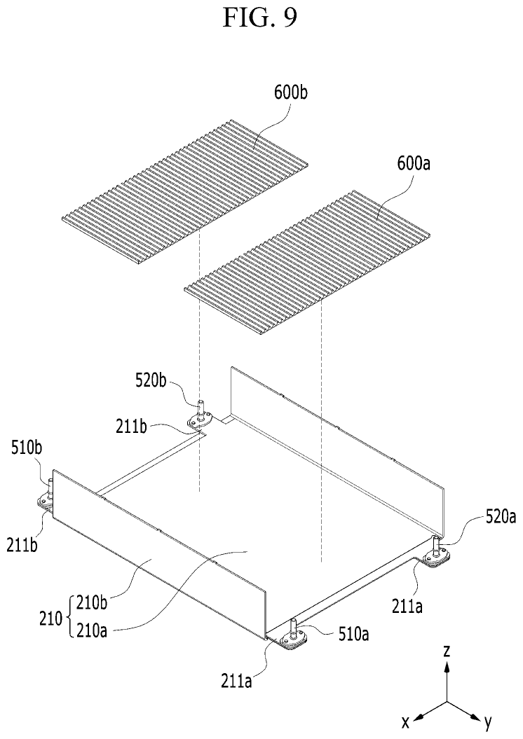

FIG. 6 is a perspective view of a first heat sink and a second heat sink included in the battery module of FIG. 4. FIG. 7 is a cross-sectional view along the line I-I′ of FIG. 6. FIG. 8 is a perspective view of the battery module when viewed from the bottom to the top so that the lower surface of the battery module of FIG. 3 can be seen. FIG. 9 is a perspective view of a lower frame, a first thermal conductive resin layer, and a second thermal conductive resin layer included in the battery module of FIG. 4.

Referring to FIG. 4 and FIGS. 6 to 9, the first heat sink 300a and the second heat sink 300b according to the present embodiment are located under the bottom part 210a of the housing 200, and first and second refrigerant flow paths are formed between the first heat sink 300a and the bottom part 210a of the housing 200 and between the second heat sink 300b and the bottom part 210a of the housing 200, respectively. The first refrigerant flow path formed by the first heat sink 300a and the second refrigerant flow path formed by the second heat sink 300b are separated from each other. In other words, the first refrigerant flowing inside the first heat sink 300a and the second refrigerant flowing inside the second heat sink 300b flow along different paths from each other without mixing. Here, the refrigerant is a medium for cooling, and is not particularly limited, but may be a cooling water.

The first heat sink 300a and the second heat sink 300b may be located separately from each other in a direction parallel to the direction in which the electrode leads 111 and 112 protrude. As described above, the electrode leads 111 and 112 in the battery cell stack 120 can protrude in the +y-axis direction and the −y-axis direction, respectively. The first heat sink 300a and the second heat sink 300b may be located separately from each other along a direction parallel to the +y-axis to comply with the protruding directions of the electrode leads 111 and 112. In particular, the first heat sink 300a and the second heat sink 300b may be located to be adjacent to both sides facing each other at the bottom part 210a of the housing 200.

Referring to FIG. 5, as described above, a portion closer to the terrace part 116 than the central part of the cell body 113 of in the battery cell 110 generates more heat during charge and discharge. With reference to the battery cell stack 120, a large amount of heat is generated in a portion adjacent to the portion where the electrode leads 111 and 112 protrude. As the charge and discharge cycles are repeated, the temperature deviation between the respective portions of the battery cell 110 becomes larger. It is important to eliminate the temperature deviation because this temperature deviation leads to deterioration of battery performance.

Referring to FIGS. 4 and 6 together with FIG. 5, the battery module 100 according to the present embodiment attempts to concentrate the cooling function and eliminate the temperature deviation of the battery cell 110 by providing the first heat sink 300a and the second heat sink 300b in a portion where heat generation is excessive in the battery cell 110. Thereby, in the battery module 100 according to the present embodiment, heat dissipation can be effectively made at both end parts of the battery cell 110 where heat generation is excessive, and the temperature deviation between the respective portions of the battery cell 110 can be minimized.

Next, specific structures of the first heat sink 300a and the second heat sink 300b will be described.

The first heat sink 300a includes a first lower plate 310a that is joined to the bottom part 210a of the housing 200, and a first recessed part 320a that is recessed in a lower direction from the second lower plate 310a. The first lower plate 310a forms a skeleton of the first heat sink 300a and can be directly joined to the bottom part 210a of the housing 200 by a welding method. Specifically, as shown in FIG. 7, the first recessed part 320a is a part that is recessed in a lower direction, and a path through which the refrigerant flows may be formed in the inside thereof.

The first recessed part 320a may be a tube in which a cross section cut in the xz plane or the yz plane perpendicular to the direction in which the refrigerant flow path extends is U-shaped, and the bottom part 210a may be located on the open upper side of the U-shaped tube. That is, as shown in FIG. 7, the first recessed part 320a may be a tube having a U-shaped cross-section. A second recessed part 320b described later also has a similar structure. As the first lower plate 310a comes into contact with the bottom part 210a, the space between the first recessed part 320a and the bottom part 210a becomes a region through which the refrigerant flows, that is, a flow path of the refrigerant. Thereby, the bottom part 210a of the housing 200 may be in direct contact with the refrigerant.

Meanwhile, the housing 200 may include first housing protrusion parts 211a formed in a part of the bottom part 210a of the housing 200. Specifically, the first housing protrusion parts 211a may be formed such that a part of the bottom part 210a of the housing 200 extends and passes through the first end plate 410. In particular, at least two first housing protrusion parts 211a may be formed, and one of the two first housing protrusion parts 211a may be connected to a refrigerant injection port 510a, and another one of the two first housing protrusion parts 211a may be connected to a refrigerant discharge port 520a. The refrigerant injection port 510a and the refrigerant discharge port 520a may be connected to a first pack refrigerant supply tube and a first pack refrigerant discharge tube, respectively, each of which will be described later.

The first heat sink 300a may include first heat sink protrusion parts 300Pa that protrudes from one side of the first heat sink 300a to a portion where the first housing protrusion parts 211a are located. At least two first housing protrusion parts 211a may be formed, and the first heat sink protrusion parts 300Pa may be formed to correspond to each of the first housing protrusion parts 211a.

The first recessed part 320a may be connected from one of the first heat sink protrusions 300Pa to another one of the first heat sink protrusions 300Pa. The refrigerant supplied via the refrigerant injection port 510a passes between the first housing protrusion part 211a and the first heat sink protrusion part 300Pa, and first flows into the space between the first recessed part 320a and the bottom part 210a. After that, the refrigerant moves along the first recessed part 320a and passes through the other first housing projection part 211a and the other first heat sink projection part 300Pa to be discharged via the refrigerant discharge port 520a.

Meanwhile, the second heat sink 300b includes a second lower plate 310b that is joined to the bottom part 210a of the housing 200, and a second recessed part 320b that is recessed in a lower direction from the second lower plate 310b. The second lower plate 310b forms a skeleton of the second heat sink 300b and may be directly joined to the bottom part 210a of the housing 200 by a welding method. The second recessed part 320b is a part recessed in the lower direction, and a path through which the refrigerant flows may be formed in the inside thereof.

The second recessed part 320b may be a tube having a U-shaped vertical cross-section in the xz plane or the yz plane with respect to the direction in which the refrigerant flow path extends, and the bottom part 210a may be located on the open upper side of the U-shaped tube. As the second lower plate 310b comes into contact with the bottom part 210a, the space between the second recessed part 320b and the bottom part 210a becomes a region through which the refrigerant flows, that is, a flow path of the refrigerant. Thereby, the bottom part 210a of the housing 200 may be in direct contact with the refrigerant.

Meanwhile, the housing 200 may include second housing protrusion parts 211b formed in a part of the bottom part 210a of the housing 200. Specifically, the second housing protrusion parts 211b may be formed such that a part of the bottom part 210a of the housing 200 extends and passes through the second end plate 420. In particular, at least two second housing protrusion parts 211b may be formed, and one of the two second housing protrusion parts 211b may be connected to a refrigerant injection port 510b, and the other of the two second housing protrusion parts 211b may be connected to a refrigerant discharge port 520b. The refrigerant injection port 510b and the refrigerant discharge port 520b may be connected to a second pack refrigerant supply tube and a second pack refrigerant discharge tube, respectively, each of which will be described later. At this time, the second housing protrusion parts 211b may be formed on sides of the bottom part 210a on which the first housing protrusion parts 211a are not formed. More specifically, the second housing protrusion parts 211b may be formed on a side opposite to the side of the bottom part 210a on which the first housing protrusion parts 211a are formed.

The second heat sink 300b may include second heat sink protrusions parts 300Pb that protrude from one side of the second heat sink 300b to a portion where the second housing protrusion parts 211b are located. At least two second housing protrusion parts 211b can be formed, and the second heat sink protrusion parts 300Pb may be formed to correspond to each of the second housing protrusion parts 211b.

The second recessed part 320b may be connected from one of the second heat sink protrusion parts 300Pb to the other one of the second heat sink protrusion parts 300Pb. The refrigerant supplied via the refrigerant injection port 510b passes between the second housing protrusion part 211b and the second heat sink protrusion part 300Pb, and first flows into the space between the second recessed part 320b and the bottom part 210a. After that, the refrigerant moves along the second recessed part 320b and passes through the other second housing protrusion 211b and the second heat sink protrusion 300Pb to be discharged via the refrigerant discharge port 520b.

In this manner, the first refrigerant flow path formed by the first recessed part 320a of the first heat sink 300a, and the second refrigerant flow path formed by the second recessed part 320b of the second heat sink 300b are separated from each other. In particular, as shown in FIG. 8, instead of covering the entire lower surface of the bottom part 210a with a single heat sink, the first heat sink 300a and the second heat sink 300b separated from each other are separately covered. If only a single heat sink is disposed, the path from where the refrigerant flows in to where the refrigerant is discharged becomes longer. If the path becomes longer, there is a problem that the pressure in the latter half of the refrigerant flow path decreases. Further, the cooling performance deteriorates in the latter half of the refrigerant flow path because heat exchange via the refrigerant has already proceeded to a considerable extent.

On the other hand, in the battery module 100 according to the present embodiment, the refrigerant path of each heat sink is shortened by disposing the first and second heat sinks 300a and 300b. Therefore, the pressure drop problem in the latter half can be solved, and the cooling performance of each heat sink can be concentrated on the area where heat generation is excessive, so that more effective heat dissipation is possible. In particular, as in the present embodiment, in the case of a large-area module in which the number of battery cells 110 is larger than that of the conventional module, it is more effective in terms of pressure maintenance and cooling performance of the refrigerant flow path than when only a single heat sink is disposed.

Further, when a large-area battery module including a single heat sink is disposed in a device such as an automobile, a large-capacity refrigerant pump is required to supply and discharge refrigerant into the single heat sink. Since such a large-capacity refrigerant pump occupies a large space, the space efficiency inside a device such as an automobile deteriorates.

On the other hand, when the separated first and second heat sinks 300a and 300b are included as in the battery module according to the present embodiment, equivalent heat exchange performance and cooling performance can be realized even with a refrigerant pump with a smaller capacity. That is, since a refrigerant pump with a smaller capacity can be used, there is an advantage that the space inside a device such as an automobile can be efficiently utilized.

Meanwhile, at least one of the first recessed part 320a and the second recessed part 320b may have a protrusion pattern P protruding in an upper direction. As in the battery cell stack 120 according to the present embodiment, in the case of a large-area battery module in which the number of stacked battery cells increases significantly compared to the conventional module, the width of the refrigerant flow path may be wider and thus, the temperature deviation may be more excessive. The protrusion pattern P can generate the effect of substantially reducing the width of the cooling flow path, minimize the pressure drop, and at the same time, reduce the temperature deviation between the widths of the refrigerant flow paths. Therefore, a uniform cooling effect can be realized.

Next, the first thermal conductive resin layer and the second thermal conductive resin layer according to an embodiment of the present disclosure will be described in detail with reference to FIGS. 9 to 11.

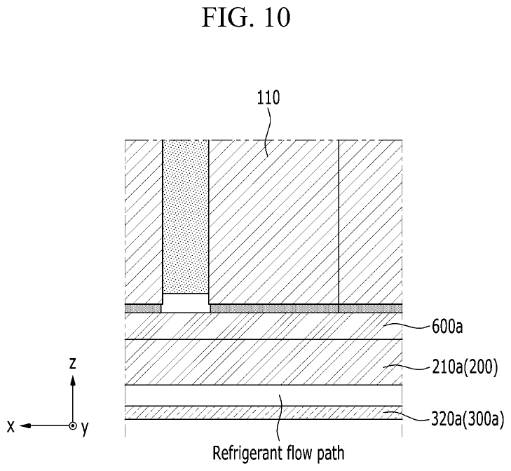

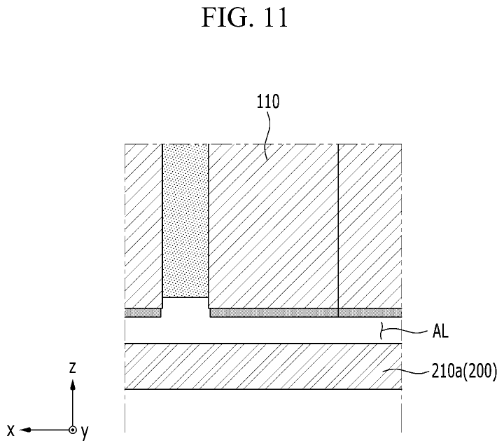

FIG. 10 is a cross-sectional view along line B-B′ of FIG. 3. FIG. 11 is a cross-sectional view along line C-C′ of FIG. 3.

Referring to FIGS. 3, 4 and 9 to 11 together, the battery module 100 according to the present embodiment may further include a first thermal conductive resin layer 600a and a second thermal conductive resin layer 600b that are located between the lower surface of the battery cell stack 120 and the bottom part 210a of the housing 200.

The first thermal conductive resin layer 600a and the second thermal conductive resin layer 600b may include a thermal conductive resin. The thermal conductive resin may be applied to the bottom part 210a of the housing 200 to form a first thermal conductive resin layer 600a and a second thermal conductive resin layer 600b. The thermal conductive resin may include a thermal conductive adhesive material, and specifically, may include at least one of a silicone material, a urethane material, and an acrylic material. The thermal conductive resin is a liquid during application but is cured after application, so that it can perform the role of fixing one or more battery cells 110 constituting the battery cell stack 120. Further, heat generated from the battery cell 100 can be quickly transferred to the outside of the battery module 100 because the thermal conductive resin has excellent heat transfer properties, thereby preventing overheating of the battery pack.

The first thermal conductive resin layer 600a and the second thermal conductive resin layer 600b may be located separately from each other in a direction parallel to the direction in which the electrode leads 111 and 112 protrude. As described above, in the battery cell stack 120, the electrode leads 111 and 112 may protrude in the +y-axis direction and the −y-axis direction, respectively. The first thermal conductive resin layer 600a and the second thermal conductive resin layer 600b may be located separately from each other in a direction parallel to the y-axis to comply with the protruding directions of the electrode leads 111 and 112. In particular, the first thermal conductive resin layer 600a and the second thermal conductive resin layer 600b may be located to be adjacent to both sides facing each other at the bottom part 210a of the housing 200, respectively. Further, with respect to a direction perpendicular to one surface of the bottom part 210a of the housing 200, the first heat sink 300a may be located at a portion corresponding to the first thermal conductive resin layer 600a, and the second heat sink 300b may be located at a portion corresponding to the second thermal conductive resin layer 600b.

Similar to the first heat sink 300a and the second heat sink 300b, the battery module 100 according to the present embodiment provides the first thermal conductive resin layer 600a and the second thermal conductive resin layer 600b in a portion where heat generation is excessive in the battery cell 110, thereby attempting to concentrate the cooling function and eliminate the temperature deviation of the battery cell 110. Thereby, in the battery module 100 according to the present embodiment, heat can be effectively dissipated at both end parts of the battery cell 110 where heat generation is excessive, and the temperature deviation between the respective parts of the battery cell 110 can be minimized.

Specifically, as shown in FIG. 10, the heat generated in the portion where the heat generation is excessive in the battery cell 110 passes through the first heat conductive resin layer 600a, the bottom part 210a of the housing 200, and the first heat sink 300a in this order to be discharged to the outside. Although not specifically shown in the figure, heat passes through the second thermal conductive resin layer 600b, the bottom part 210a of the housing 200, and the second heat sink 300b in this order similarly on the opposite side for the heat dissipated to be discharged to the outside.

On the other hand, as shown in FIG. 11, in the portion where the heat of the battery cell 110 is relatively weak, the thermal conductive resin is not applied, and thus a kind of air layer AL may be formed between the battery cell 110 and the bottom part 210a of the housing 200. The air layer AL may function as a heat insulating layer and can relatively limit the heat discharge. In addition, a separate heat sink is not disposed in the corresponding part.

As described above, the degree of heat discharge is designed differently for each of the portions where heat generation of the battery cell 110 is excessive and the portion where the heat generation is minimal, thereby attempting to eliminate the temperature deviation between the respective parts of the battery cell 110.

Considering in a comprehensive way, first heat sink 300a and the second heat sink 300b are disposed to correspond to each of the portions to which the first thermal conductive resin layer 600a and the second thermal conductive resin layer 600b are applied, whereby it is possible to maximize the cooling performance of the portion where heat generation of the battery cell stack 120 is excessive. Further, in the portion where heat generation of the battery cell stack 120 is weak, it was attempted to relatively limit the cooling performance to balance the temperature deviation.

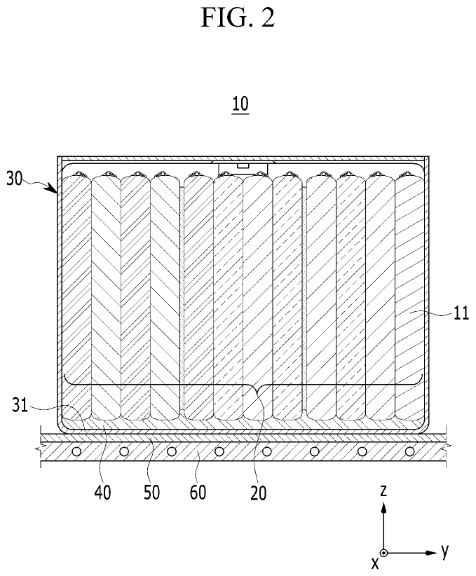

On the other hand, referring back to FIGS. 2, 6, 7 and 10, in the case of the conventional battery module 10, the refrigerant flow path is formed inside the heat sink 60, whereas the first heat sink 300a and the second heat sink 300b according to the present embodiment include the first recessed part 320a and the second recessed part 320b that have open upper parts, so that the bottom part 210a of the housing 200 is in direct contact with the refrigerant. That is, the bottom part 210a of the housing 200 is constituted by an upper plate of each of the first heat sink 300a and the second heat sink 300b. Thereby, the battery module 100 according to the present embodiment has an advantage that more heat can be transferred directly as compared with the conventional heat sink 60.

Next, a battery pack according to an embodiment of the present disclosure will be described in detail with reference to FIGS. 4, 8, 9 and 12.

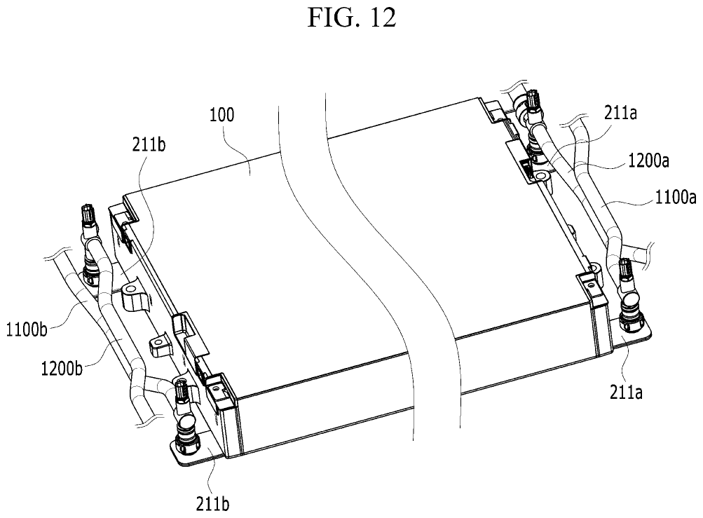

FIG. 12 is a perspective view of a battery module, a pack refrigerant supply tube, and a pack refrigerant discharge tube according to an embodiment of the present disclosure.

Referring to FIGS. 4, 8, 9 and 12, the battery pack according to an embodiment of the present disclosure includes a battery module 100, a first pack refrigerant supply tube 1100a, a first pack refrigerant discharge tube 1200a, a second pack refrigerant supply tube 1100b and a second pack refrigerant discharge tube 1200b.

The first pack refrigerant supply tube 1100a supplies a refrigerant to the refrigerant flow path formed by the first heat sink 300a. Specifically, the first pack refrigerant supply tube 1100a may be connected to the refrigerant injection port 510a. The refrigerant that has moved through the first pack refrigerant supply tube 1100a passes through the refrigerant injection port 510a and between the first housing protrusion part 211a and the first heat sink protrusion part 300Pa in this order and flows into the first heat sink 300a.

The first pack refrigerant discharge tube 1200a discharges the refrigerant from the refrigerant flow path formed by the first heat sink 300a. Specifically, the first pack refrigerant discharge tube 1200a may be connected to the refrigerant discharge port 520a. The refrigerant flowing into the first heat sink 300a passes through between the other first housing protrusion part 211a and the first heat sink protrusion part 300Pa and through the refrigerant discharge port 520a in this order to be discharged to the first pack refrigerant discharge tube 1200a.

Meanwhile, the second pack refrigerant supply tube 1100b supplies a refrigerant to the refrigerant flow path formed by the second heat sink 300b. Specifically, the second pack refrigerant supply tube 1100b may be connected to the refrigerant injection port 510b. The refrigerant that has moved through the second pack refrigerant supply tube 1100b passes through the refrigerant injection port 510b and between the second housing protrusion port 211b and the second heat sink protrusion part 300Pb in this order and flows into the second heat sink 300b.

The second pack refrigerant discharge tube 1200b discharges the refrigerant from the refrigerant flow path formed by the second heat sink 300b. Specifically, the second pack refrigerant discharge tube 1200b may be connected to the refrigerant discharge port 520b. The refrigerant flowing into the second heat sink 300b passes between the other second housing protrusion part 211b and the second heat sink protrusion part 300Pb and through the refrigerant discharge port 520b in this order to be discharged to the second pack refrigerant discharge tube 1200b.

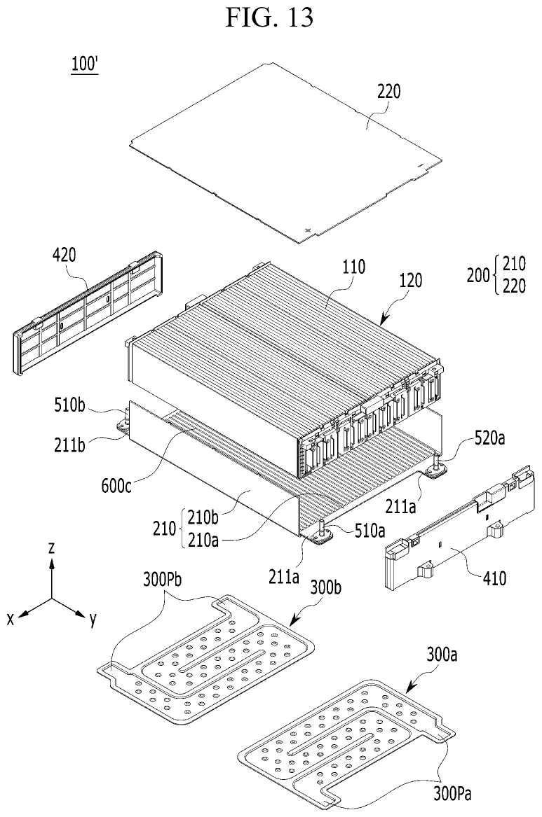

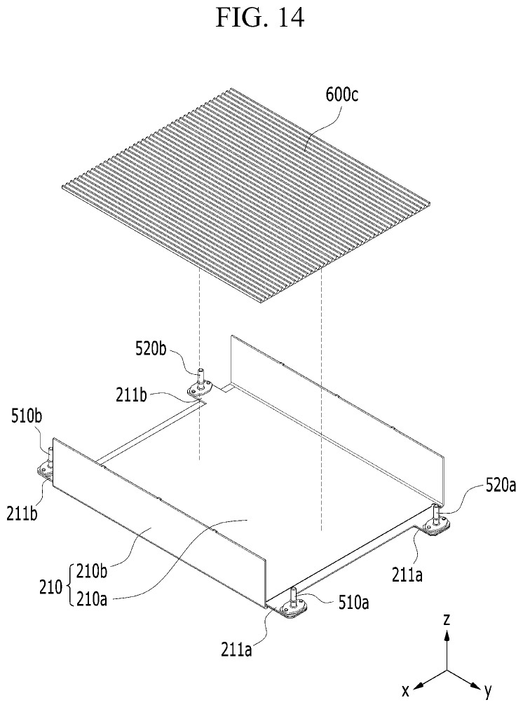

Next, a battery module according to another embodiment of the present disclosure will be described with reference to FIGS. 13 and 14.

FIG. 13 is an exploded perspective view of a battery module according to another embodiment of the present disclosure. FIG. 14 is a perspective view of a lower frame and a thermal conductive resin layer included in the battery module of FIG. 13.

Referring to FIGS. 13 and 14, the battery module 100′ according to another embodiment of the present disclosure includes a battery cell stack 120 in which a plurality of battery cells 110 are stacked; a housing 200 that houses the battery cell stack 120; and a first heat sink 300a and a second heat sink 300b that are located under the bottom part 210a of the housing 200. The housing 200 may include a lower frame 210 and an upper cover 220, and a first end plate 410 and a second end plate 420 may be disposed in each of the front surface and the rear surface of the battery cell stack 120. The details concerning each configuration overlaps with the contents previously described, and thus are omitted.

At this time, the battery module 100′ according to the present embodiment may further include a thermal conductive resin layer 600c located between the lower surface of the battery cell stack 120 and the bottom part 210a of the housing 200. A thermal conductive resin can be applied to the bottom part 210a of the housing 200 to form a thermal conductive resin layer 600c. Details concerning the thermal conductive resin overlap with the contents previously described, and thus are omitted.

The battery module 100 described above includes a first thermal conductive resin layer 600a and a second thermal conductive resin layer 600b corresponding to the first heat sink 300a and the second heat sink 300b, respectively, whereas the battery module 100′ according to the present embodiment may include a single thermal conductive resin layer 600c.

With respect to a direction perpendicular to one surface of the bottom part 210a of the housing 200, the thermal conductive resin layer 600c according to the present embodiment covers a region where the first heat sink 300a is located and a region where the second heat sink 300b is located.

That is, not only can the thermal conductive resin layer 600c cover the region where the first heat sink 300a is located and the region where the second heat sink 300b is located, but it can also cover the region located between them. 1. Thereby, the heat dissipation performance in the central part of the battery cell 110 may be complemented.

The first and second thermal conductive resin layers 600a and 600b or a single thermal conductive resin layer 600c may be selected and applied to improve heat dissipation performance and minimize temperature deviation for each battery module based on the type, number, size, etc. of the applied battery cells 110.

Even though the terms indicating directions such as front, rear, left, right, upper, and lower directions are used herein, it is obvious to those skilled in the art that these merely represent for convenience of explanation, and may differ depending on a position of an observer, a position of an object, or the like.

The one or more battery modules according to the present embodiment as described above can be mounted together with various control and protection systems such as a battery management system (BMS) and a cooling system to form a battery pack.

The battery module or the battery pack can be applied to various devices. Specifically, these devices can be applied to vehicle means such as an electric bicycle, an electric vehicle, a hybrid vehicle, but the present disclosure is not limited thereto and can be applied to various devices that can use the secondary battery.

Although the preferred embodiments of the present disclosure have been described in detail above, the scope of the present disclosure is not limited thereto, and various modifications and improvements made by those skilled in the art using the basic concepts of the present disclosure defined in the following claims also fall within the spirit and scope of the present disclosure.

1. A battery module comprising:
a battery cell stack in which a plurality of battery cells including electrode leads protruding in mutually opposite directions are stacked;
a module frame that houses the battery cell stack; and
a first heat sink and a second heat sink that are located under the bottom part of the module frame;
wherein a refrigerant flow path is formed between the first heat sink and the bottom part of the module frame and between the second heat sink and the bottom part of the module frame, respectively, and
wherein the refrigerant flow path formed by the first heat sink and the refrigerant flow path formed by the second heat sink are separated from each other.

2. The battery module according to claim 1, wherein:
the first heat sink and the second heat sink are located separately from each other along a direction parallel to a direction in which the electrode leads protrude.

3. The battery module according to claim 1,
which further comprises a first thermal conductive resin layer and a second thermal conductive resin layer that are located between the lower surface of the battery cell stack and the bottom part of the module frame.

4. The battery module according to claim 3, wherein:
the first thermal conductive resin layer and the second thermal conductive resin layer are located separately from each other along a direction parallel to a direction in which the electrode leads protrude.

5. The battery module according to claim 3, wherein:
the first heat sink is located at a portion corresponding to the first thermal conductive resin layer, and the second heat sink is located at a portion corresponding to the second thermal conductive resin layer, with respect to a direction perpendicular to one surface of the bottom part of the module frame.

6. The battery module according to claim 1, wherein:
the first heat sink comprises a first lower plate that is joined to the bottom part of the module frame, and a first recessed part that is recessed in a lower direction from the first lower plate.

7. The battery module according to claim 1,
which further comprises a thermal conductive resin layer that is located between the lower surface of the battery cell stack and the bottom part of the module frame.

8. The battery module according to claim 7, wherein:
the thermal conductive resin layer covers a region where the first heat sink is located and a region where the second heat sink is located, with respect to a direction perpendicular to one surface of the bottom part of the module frame.

9. The battery module according to claim 1, wherein:
the module frame comprises first module frame protrusion part that is formed by protruding a part of the bottom part of the module frame, and
a refrigerant injection port is connected to any one of the first module frame protrusion parts and a refrigerant discharge port is connected to the other one.

10. The battery module according to claim 9, wherein:
the first heat sink comprises first heat sink protrusion parts that protrudes from one side of the first heat sink to portions where the first module frame protrusion parts are located.

11. The battery module according to claim 1, wherein:
the second heat sink comprises a second lower plate that is joined to the bottom part of the module frame, and a second recessed part that is recessed in a lower direction from the second lower plate.

12. The battery module according to claim 1, wherein:
the module frame comprises second module frame protrusion parts formed by protruding a part of the bottom part of the module frame, and
a refrigerant injection port is connected to any one of the second module frame protrusion parts, and a refrigerant discharge port is connected to the other one.

13. The battery module according to claim 12, wherein:
the second heat sink comprises second heat sink protrusion parts that protrudes from one side of the second heat sink to portions where the second module frame protrusion parts are located.

14. A battery pack comprising:
the battery module according to claim 1;
a first pack refrigerant supply tube that supplies a refrigerant to a refrigerant flow path formed by a first heat sink;
a first pack refrigerant discharge tube that discharges the refrigerant from the refrigerant flow path formed by the first heat sink;
a second pack refrigerant supply tube that supplies a refrigerant to the refrigerant flow path formed by the second heat sink; and
a second pack refrigerant discharge tube that discharges the refrigerant from the refrigerant flow path formed by the second heat sink.
